(19) United States
(12) Patent Application Publication
(10) Pub. No.: US 2024/0407048 A1
(43) Pub. Date: Dec. 5, 2024

(54) METHOD AND DEVICE FOR PERFORMING SIDELINK DRX

(71) Applicant: ZTE CORPORATION, Shenzhen (CN)

(72) Inventors: Wei LUO, Shenzhen (CN); Weiqiang DU, Shenzhen (CN); Lin CHEN, Shenzhen (CN)

(73) Assignee: ZTE CORPORATION, Shenzhen (CN)

(21) Appl. No.: 18/799,145

(22) Filed: Aug. 9, 2024

Related U.S. Application Data
(63) Continuation of application No. PCT/CN2022/076061, filed on Feb. 11, 2022.

(51) Int. Cl. H04W 76/28; H04W 92/18

(52) U.S. Cl. CPC H04W 76/28; H04W 92/18

(57) ABSTRACT

Method, device and computer program product for wireless communication are provided. A method includes: transmitting, by a first wireless communication terminal to a second wireless communication terminal, an indication to prevent the second wireless communication terminal from sending sidelink assistance information in response to a first capability indication indicating the first wireless communication terminal supporting a sidelink Discontinuous Reception, DRX or supporting a sidelink Discontinuous transmission, DTX, being transmitted to the second wireless communication terminal and a serving cell of the first wireless communication terminal not supporting the sidelink DRX.

### CROSS-REFERENCE TO RELATED APPLICATION

This application claims the benefit of priority under 35 U.S.C. § 120 as a continuation of International Patent Application No. PCT/CN2022/076061, filed on Feb. 11, 2022, the disclosure of which is incorporated herein by reference in its entirety.

### FIELD OF DISCLOSURE

This document is directed generally to wireless communications, and in particular to 5^{th} generation (5G) communications. More specifically, this document is directed to methods, systems, and devices to configure discontinuous reception for sidelink (SL) transmission between communication terminals.

### BACKGROUND

Sidelink is a unilateral wireless communication service, i.e., the communication between the communication terminals. Vehicle networking refers to a large scale system for wireless communication and information exchange among vehicles, pedestrians, roadside equipments, and internet in accordance with agreed communication protocols and data exchange standards.

The vehicle networking communication can help in driving safety, improving traffic efficiency, and acquiring information for everyday life or entertainment.

### SUMMARY

The vehicle networking communication may be categorized into three types as per the objects of wireless communication: the communication between vehicles, i.e., vehicle-to-vehicle (V2V); the communication between vehicles and roadside equipments/network infrastructures, i.e., vehicle-to-infrastructure/vehicle-to-network (V2I/V2N); and the communication between vehicles and pedestrians, i.e., vehicle-to-pedestrian (V2P). These types of communications collectively are referred to as vehicle-to-everything (V2X) communication.

In the V2X communication research of 3rd Generation Partnership Project (3GPP), the sidelink based V2X communication method between user equipments is one of the manners to implement the V2X standard, in which traffic data is directly transmitted from a source user equipment to a destination user equipment via an air interface without forwarding by the base station and the core network, as shown in FIG. 1.

FIG. 1 illustrates an example scenario of a V2X sidelink communication/discovery. The V2X communication is referred to as a PC5-based V2X communication or a V2X sidelink communication.

With the technology advancement and development of the automation industry, the scenarios for the V2X communications are further diversified. The advanced V2X services include vehicle platooning, extended sensors, advanced driving (semi-automated driving and full-automated driving), and remote driving. The desired performance requirements may include: a supporting data packet with the size of 50 to 12000 bytes, a transmission rate with 2 to 50 messages per second, the maximum end-to-end delay of 3 to 500 milliseconds, a reliability of 90% to 99.999%, a data rate of 0.5 to 1000 Mbps, and a transmission range of 50 to 1000 meters.

For sidelink communications, such as the V2X communications, the UE needs to monitor sidelink signals within the whole sidelink receiving resource pool, which cause significant power consumption and low efficiency.

In some cases, the serving cell of the UE needs to be evolved to help the configuration of the SL DRX (discontinuous reception). If the serving cell of the UE cannot support a SL DRX function, the configuration of the SL DRX would be impossible.

One aspect of the present disclosure relates to a wireless communication method. In an embodiment, the wireless communication method includes: transmitting, by a first wireless communication terminal to a second wireless communication terminal, an indication to prevent the second wireless communication terminal from sending sidelink assistance information in response to a first capability indication indicating the first wireless communication terminal supporting a sidelink Discontinuous Reception, DRX or supporting a sidelink Discontinuous transmission, DTX, being transmitted to the second wireless communication terminal and a serving cell of the first wireless communication terminal not supporting the sidelink DRX.

Another aspect of the present disclosure relates to a wireless communication method. In an embodiment, the wireless communication method includes: receiving, by a second wireless communication terminal from a first wireless communication terminal, an indication; and refraining, by the second wireless communication terminal, from sending sidelink assistance information according to the indication; wherein the indication is received after a first capability indication indicating the first wireless communication terminal supporting a sidelink Discontinuous Reception, DRX, or supporting a sidelink Discontinuous Transmission, DTX, being received by the second wireless communication terminal and in response to a serving cell of the first wireless communication terminal not supporting the sidelink DRX.

Another aspect of the present disclosure relates to a wireless communication method. In an embodiment, the wireless communication method includes: transmitting, by a wireless communication terminal to a wireless communication node, a QoS profile of a sidelink QoS flow with an indication for at least one of data transmission or data reception.

Another aspect of the present disclosure relates to a wireless communication method. In an embodiment, the wireless communication method includes: performing, by a wireless communication terminal, a sidelink groupcast or broadcast communication according to a sidelink DRX configuration in a preconfigured message or in a system information of a cell on a frequency providing the sidelink DRX configuration in response to a serving cell of the wireless communication terminal not supporting the sidelink DRX.

Another aspect of the present disclosure relates to a wireless communication method. In an embodiment, the wireless communication method includes: performing, by a first wireless communication terminal, a cell reselection by taking a carrier frequency providing a sidelink DRX configuration as a highest priority carrier frequency.

Another aspect of the present disclosure relates to a wireless communication method. In an embodiment, the wireless communication method includes: starting, by a second wireless communication terminal, a timer upon sending assistance information to a first wireless communication terminal in response to the first wireless communication terminal configures a sidelink DRX configuration for the second wireless communication terminal or the first wireless communication terminal is configured with a sidelink resource allocation mode 2; and releasing, by a second wireless communication terminal, a PC5 link with a first wireless communication terminal or using a default sidelink DRX configuration which is preconfigured or is received from a serving cell of the second wireless communication terminal in response to the timer expires.

Another aspect of the present disclosure relates to a wireless communication method. In an embodiment, the wireless communication method includes: incrementing, by a second wireless communication terminal, a value of a counter in response to the second wireless communication terminal sending a sidelink DRX rejection indication to a first wireless communication terminal; and releasing, by a second wireless communication terminal, a PC5 link with a first wireless communication terminal or using a default sidelink DRX configuration which is preconfigured or is received from a serving cell of the second wireless communication terminal in response to the value of the counter exceeds a threshold.

Another aspect of the present disclosure relates to a wireless communication terminal. In an embodiment, the wireless communication terminal includes a communication unit and a processor. The processor transmits, to a second wireless communication terminal, an indication to prevent the second wireless communication terminal from sending sidelink assistance information in response to a first capability indication indicating the first wireless communication terminal supporting a sidelink Discontinuous Reception, DRX or supporting a sidelink Discontinuous transmission, DTX, being transmitted to the second wireless communication terminal and a serving cell of the first wireless communication terminal not supporting the sidelink DRX.

Another aspect of the present disclosure relates to a wireless communication terminal. In an embodiment, the wireless communication terminal includes a communication unit and a processor. The processor receives, from a first wireless communication terminal, an indication; and refraining from sending sidelink assistance information according to the indication; wherein the indication is received after a first capability indication indicating the first wireless communication terminal supporting a sidelink Discontinuous Reception, DRX, or supporting a sidelink Discontinuous Transmission, DTX, being received by the second wireless communication terminal and in response to a serving cell of the first wireless communication terminal not supporting the sidelink DRX.

Another aspect of the present disclosure relates to a wireless communication terminal. In an embodiment, the wireless communication terminal includes a communication unit and a processor. The processor transmits, to a wireless communication node, a QoS profile of a sidelink QoS flow with an indication for at least one of data transmission or data reception.

Another aspect of the present disclosure relates to a wireless communication terminal. In an embodiment, the wireless communication terminal includes a communication unit and a processor. The processor performs a sidelink groupcast or broadcast communication according to a sidelink DRX configuration in a preconfigured message or in a system information of a cell on a frequency providing the sidelink DRX configuration in response to a serving cell of the wireless communication terminal not supporting the sidelink DRX.

Another aspect of the present disclosure relates to a wireless communication terminal. In an embodiment, the wireless communication terminal includes a communication unit and a processor. The processor performs a cell reselection by taking a carrier frequency providing a sidelink DRX configuration as a highest priority carrier frequency.

Another aspect of the present disclosure relates to a wireless communication terminal. In an embodiment, the wireless communication terminal includes a communication unit and a processor. The processor starts a timer upon sending assistance information to a first wireless communication terminal in response to the first wireless communication terminal configures a sidelink DRX configuration for the second wireless communication terminal or the first wireless communication terminal is configured with a sidelink resource allocation mode 2; and release a PC5 link with a first wireless communication terminal or using a default sidelink DRX configuration which is preconfigured or is received from a serving cell of the second wireless communication terminal in response to the timer expires.

Another aspect of the present disclosure relates to a wireless communication terminal. In an embodiment, the wireless communication terminal includes a communication unit and a processor. The processor increments a value of a counter in response to the second wireless communication terminal sending a sidelink DRX rejection indication to a first wireless communication terminal; and release a PC5 link with a first wireless communication terminal or using a default sidelink DRX configuration which is preconfigured or is received from a serving cell of the second wireless communication terminal in response to the value of the counter exceeds a threshold.

Various embodiments may preferably or in some embodiments implement the following features:

Preferably or in some embodiments, the indication comprises at least one of: an indication indicating that the sidelink assistance information is not allowed to be transmitted, or an indication indicating that a sidelink DRX configuration of the second wireless communication terminal is unable to be configured by the first wireless communication terminal or the a serving cell of the first wireless communication terminal.

Preferably or in some embodiments, the first wireless communication terminal transmits a second capability indication indicating that the first wireless communication terminal does not support the sidelink DRX in response to the first wireless communication terminal being in a Radio Resource Control, RRC, connected mode and the serving cell of the first wireless communication terminal not supporting the sidelink DRX.

Preferably or in some embodiments, the first wireless communication terminal reports a sidelink DRX configuration for the second wireless communication terminal to a wireless communication node in response to a message indicating the sidelink DRX configuration being accepted by the second wireless communication terminal and the serving cell of the first wireless communication terminal supporting the sidelink DRX.

Preferably or in some embodiments, the first wireless communication terminal determines the serving cell of the first wireless communication terminal not supporting the sidelink DRX in response to not receiving information of sidelink DRX configuration or sidelink DRX support indication from the serving cell.

Preferably or in some embodiments, the first wireless communication terminal reports a sidelink DRX configuration for the second wireless communication terminal to a wireless communication node in response to a message indicating the sidelink DRX configuration being accepted by the second wireless communication terminal and the wireless communication node supporting the sidelink DRX.

Preferably or in some embodiments, the first wireless communication terminal determines a sidelink DRX configuration for the second wireless communication terminal taking into account a Uu DRX configuration of the second wireless communication terminal in the sidelink assistance information from the second wireless communication terminal.

Preferably or in some embodiments, the first wireless communication terminal transmits the sidelink assistance information received from the second wireless communication terminal to a wireless communication node in response to one of:
the first wireless communication terminal being in an RRC connected mode and the wireless communication node configuring to change a sidelink resource allocation mode from mode 2 to mode 1;
the first wireless communication terminal switching from an RRC idle or inactive mode to an RRC connected mode;
a handover of the first wireless communication terminal succeeding; or
a connection reestablishment of the first wireless communication terminal succeeding.

Preferably or in some embodiments, the first wireless communication terminal transmits the sidelink DRX configuration of the second wireless communication terminal to a wireless communication node in response to at least one of:

the first wireless communication terminal being in an RRC connected mode and the wireless communication node configuring to change a sidelink resource allocation mode from mode 2 to mode 1;
the first wireless communication terminal switching from an RRC idle or inactive mode to an RRC connected mode;
a handover of the first wireless communication terminal succeeding; or
a connection reestablishment of the first wireless communication terminal succeeding.

Preferably or in some embodiments, the second wireless communication terminal receives a second capability indication indicating the first wireless communication terminal does not support the sidelink DRX in response to the first wireless communication terminal being in a Radio Resource Control, RRC, connected mode and the serving cell of the first wireless communication terminal not supporting the sidelink DRX.

Preferably or in some embodiments, the second wireless communication terminal transmits a Uu DRX configuration of the second wireless communication terminal to the first wireless communication terminal in the sidelink assistance information in response to a serving cell of the second wireless communication terminal not supporting the sidelink DRX.

Preferably or in some embodiments, the second wireless communication terminal refrains from transmitting at least one of a sidelink DRX configuration or a quality of service, QoS, profile of interested receiving service for a sidelink QoS flow to a wireless communication node. Preferably or in some embodiments, the indication indicates whether the wireless communication terminal is interested to receive a sidelink communication for one or more destination identities.

Preferably or in some embodiments, the indication comprises a list with a plurality of entries, a number of the entries is identical to a number of entries in a sidelink transmission resource request list, and the entries in the list are listed in a same order as the entries in the sidelink transmission resource request list.

Preferably or in some embodiments, the second wireless communication terminal receives an indication from the first wireless communication terminal indicating at least one of: the first wireless communication terminal or a serving cell of the first wireless communication terminal configures the sidelink DRX configuration for the second wireless communication terminal; or the first wireless communication terminal is configured with a sidelink resource allocation mode 1 or the sidelink resource allocation mode 2.

Preferably or in some embodiments, the second wireless communication terminal stops the timer in response to receiving the sidelink DRX configuration from the first wireless communication terminal.

Preferably or in some embodiments, the value of the timer is preconfigured or is received from the serving cell of the second wireless communication terminal.

Preferably or in some embodiments, the second wireless communication terminal initializes the value of the counter to zero in response to the second wireless communication terminal sending a sidelink DRX accept indication to a first wireless communication terminal.

Preferably or in some embodiments, the threshold is preconfigured or received from a serving cell of the second wireless communication terminal.

Preferably or in some embodiments, the second wireless communication terminal increments the value of a counter when following conditions are met: the second wireless communication terminal sends a sidelink DRX rejection indication to the first wireless communication terminal; and the first wireless communication terminal configures a sidelink DRX configuration for the second wireless communication terminal or the first wireless communication terminal is configured with a sidelink resource allocation mode 2.

Preferably or in some embodiments, the second wireless communication terminal receives an indication from the first wireless communication terminal indicating at least one of:
the first wireless communication terminal or a serving cell of the first wireless communication terminal configures the sidelink DRX configuration for the second wireless communication terminal; or
the first wireless communication terminal is configured with a sidelink resource allocation mode 1 or the sidelink resource allocation mode 2.

The present disclosure relates to a computer program product comprising a computer-readable program medium code stored thereupon, the code, when executed by a processor, causing the processor to implement a wireless communication method recited in any one of foregoing methods.

The example embodiments disclosed herein are directed to providing features that will become readily apparent by reference to the following description when taken in conjunction with the accompany drawings. In accordance with various embodiments, example systems, methods, devices and computer program products are disclosed herein. It is understood, however, that these embodiments are presented by way of example and not limitation, and it will be apparent to those of ordinary skill in the art who read the present disclosure that various modifications to the disclosed embodiments can be made while remaining within the scope of the present disclosure.

Thus, the present disclosure is not limited to the example embodiments and applications described and illustrated herein. Additionally, the specific order and/or hierarchy of steps in the methods disclosed herein are merely example approaches. Based upon design preferences, the specific order or hierarchy of steps of the disclosed methods or processes can be re-arranged while remaining within the scope of the present disclosure. Thus, those of ordinary skill in the art will understand that the methods and techniques disclosed herein present various steps or acts in a sample order, and the present disclosure is not limited to the specific order or hierarchy presented unless expressly stated otherwise.

### BRIEF DESCRIPTION OF THE DRAWINGS

The above and other aspects and their implementations are described in greater detail in the drawings, the descriptions, and the claims.

FIG. 1 illustrates an example scenario of V2X sidelink communication/discovery according to an embodiment of the present disclosure.

FIG. 2 shows a schematic diagram of a wireless terminal according to an embodiment of the present disclosure.

FIG. 3 shows a schematic diagram of a wireless network node according to an embodiment of the present disclosure.

FIG. 4 shows a flowchart of the sidelink UE capability transfer process according to an embodiment of the present disclosure.

FIGS. 5 to 11 show flowcharts of a wireless communication method according to an embodiment of the present disclosure.

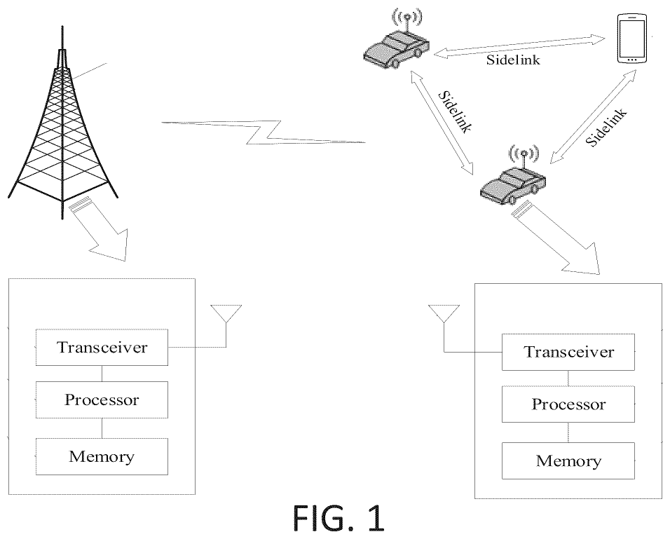

### DETAILED DESCRIPTION

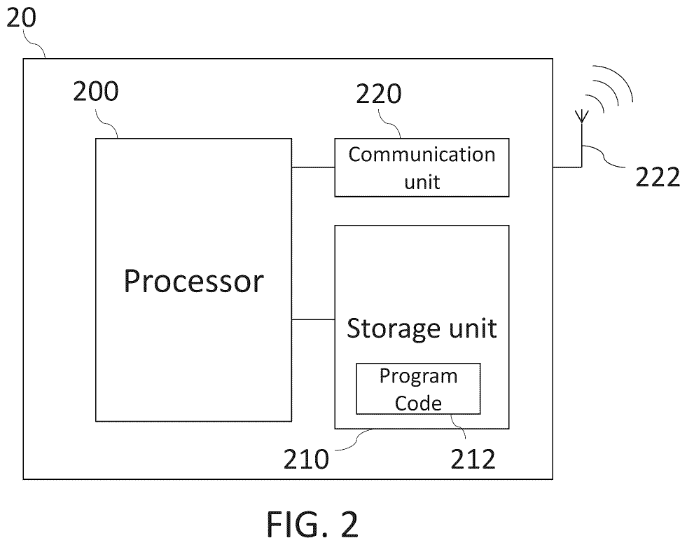

FIG. 2 relates to a schematic diagram of a wireless terminal 20 according to an embodiment of the present disclosure. The wireless terminal 20 may be a user equipment (UE), a transmitting UE (TX UE), a receiving UE (RX UE), a mobile phone, a laptop, a tablet computer, an electronic book or a portable computer system and is not limited herein. The wireless terminal 20 may include a processor 200 such as a microprocessor or Application Specific Integrated Circuit (ASIC), a storage unit 210 and a communication unit 220. The storage unit 210 may be any data storage device that stores a program code 212, which is accessed and executed by the processor 200. Embodiments of the storage unit 212 include but are not limited to a subscriber identity module (SIM), read-only memory (ROM), flash memory, random-access memory (RAM), hard-disk, and optical data storage device. The communication unit 220 may a transceiver and is used to transmit and receive signals (e.g. messages or packets) according to processing results of the processor 200. In an embodiment, the communication unit 220 transmits and receives the signals via at least one antenna 222 shown in FIG. 2.

In an embodiment, the storage unit 210 and the program code 212 may be omitted and the processor 200 may include a storage unit with stored program code.

The processor 200 may implement any one of the steps in exemplified embodiments on the wireless terminal 20, e.g., by executing the program code 212.

The communication unit 220 may be a transceiver. The communication unit 220 may as an alternative or in addition be combining a transmitting unit and a receiving unit configured to transmit and to receive, respectively, signals to and from a wireless network node (e.g. a base station) and/or another wireless communication terminal.

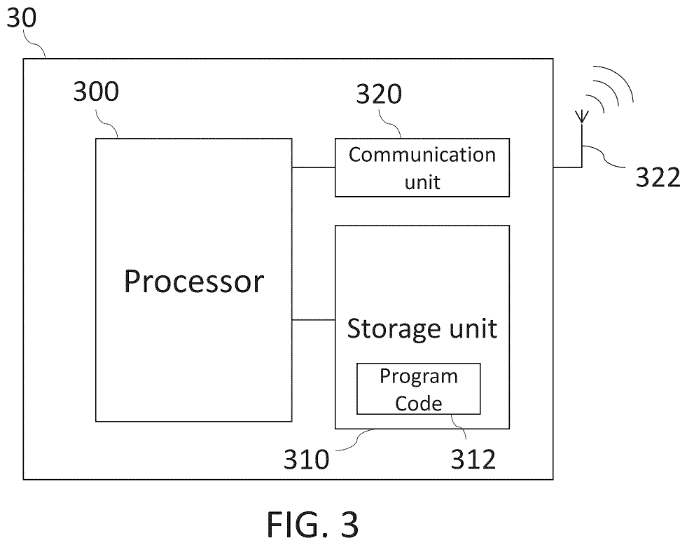

FIG. 3 relates to a schematic diagram of a wireless network node 30 according to an embodiment of the present disclosure. The wireless network node 30 may be a satellite, a base station (BS), a smart node, a network entity, a Mobility Management Entity (MME), Serving Gateway (S-GW), Packet Data Network (PDN) Gateway (P-GW), a radio access network (RAN) node, a next generation RAN (NG-RAN) node, a gNB, an eNB, a gNB central unit (gNB-CU), a gNB distributed unit (gNB-DU) a data network, a core network or a Radio Network Controller (RNC), and is not limited herein. In addition, the wireless network node 30 may comprise (perform) at least one network function such as an access and mobility management function (AMF), a session management function (SMF), a user place function (UPF), a policy control function (PCF), an application function (AF), etc. The wireless network node 30 may include a processor 300 such as a microprocessor or ASIC, a storage unit 310 and a communication unit 320. The storage unit 310 may be any data storage device that stores a program code 312, which is accessed and executed by the processor 300. Examples of the storage unit 312 include but are not limited to a SIM, ROM, flash memory, RAM, hard-disk, and optical data storage device. The communication unit 320 may be a transceiver and is used to transmit and receive signals (e.g. messages or packets) according to processing results of the processor 300. In an example, the communication unit 320 transmits and receives the signals via at least one antenna 322 shown in FIG. 3.

In an embodiment, the storage unit 310 and the program code 312 may be omitted. The processor 300 may include a storage unit with stored program code.

The processor 300 may implement any steps described in exemplified embodiments on the wireless network node 30, e.g., via executing the program code 312.

The communication unit 320 may be a transceiver. The communication unit 320 may as an alternative or in addition be combining a transmitting unit and a receiving unit configured to transmit and to receive, respectively, signals to and from a wireless terminal (e.g. a user equipment or another wireless network node).

In an embodiment, a timer-based SL DRX for unicast, groupcast, and broadcast is supported. Parameters, such as an on-duration, an inactivity-timer, a retransmission-timer, and/or a cycle, are defined for SL communications to determine the SL active time for the SL DRX. During the SL active time, the UE performs SCI (sidelink control information) monitoring for the data reception (i.e., the PSCCH (Physical Sidelink. Control Channel) and the second stage SCI on the PSSCH). The UE may skip the monitoring of SCI for the data reception during the SL DRX inactive time.

The SL active time of the RX UE includes the time corresponding to, when applicable, the on-duration timer(s), the inactivity-timer(s) or the retransmission timer(s) (for any of the unicast, groupcast, or broadcast).

The TX UE maintains a set of timers corresponding to the SL DRX timers in the RX UE(s) for each pair of source/destination L2 (Layer 2) IDs (identifiers) for the unicast and/or for destination L2 IDs for groupcast/broadcast, and uses the timers as part of the criterion for determining the allowable transmission time with the RX UE(s). When data is available to be transmitted to one or more RX UE(s) in DRX, the TX UE selects resources according to the active time of the RX UE(s) determined by the timers maintained by the TX UE.

For unicast, the SL DRX is configured for each pair of the source L2 ID and the destination L2 ID.

The UE maintains a set of SL DRX timers for each direction per pair of source L2 ID and destination L2 ID. In DRX configuration of each direction, one UE is the TX UE and the other is the RX UE. The RX UE may send assistance information, which includes its preference of the on duration timer, the DRX start offset, and the DRX cycle, to the TX UE and the TX UE may use the assistance information to determine the SL DRX configuration for the RX UE. The RX UE may send the SL DRX assistance information when the previously transmitted assistance information has changed.

### Embodiment 1

In an embodiment, the UE may transmit or receive a sidelink communication data using SL DRX. When the UE is in-coverage for sidelink operations, the UE may perform an NR (new radio) sidelink communication according to the SL DRX configuration in System Information, and when out-of-coverage for sidelink operations, the UE may perform sidelink communication according to the SL DRX configuration in an SL-V2X-PreconfigurationNR or SystemInformation message of the cell on the frequency which provides the inter-carrier NR sidelink configuration.

In this embodiment, when the UE is interested to perform a NR sidelink communication on a non-serving frequency, it may perform measurements on that frequency or the frequencies which can provide inter carrier NR sidelink configurations for that frequency for cell selection and reselection.

In this embodiment, if the UE has selected a cell on a non-serving frequency for NR sidelink communication, it may perform additional reselection process to select a better cell for sidelink operation.

In this embodiment, when the UE (e.g., TX UE or RX UE) performs cell reselection, the UE interested in V2X service(s) considers at least whether NR sidelink communication and/or V2X sidelink communication are supported by the cell. The UE may consider the following carrier frequency as the highest priority frequency: the frequency providing the NR sidelink DRX configuration, if the UE is configured to perform the NR sidelink communication and the UE has the capability for SL DRX.

### Embodiment 2

In an embodiment, a UE may receive a first DRX configuration information from the wireless network access node. For example, the UE may receive the first DRX configuration information via a radio resource control (RRC) dedicated message or a broadcast message.

In an implementation of this embodiment, the first DRX configuration information may include a subset of DRX configuration parameters that are required to configure the sidelink DRX. For example, the first DRX configuration information may include DRX configuration parameters drx-LongCycleStartOffset, drx-LongCycle, and drx-StartOffset.

In another implementation of this embodiment, the first DRX configuration information may include a complete set of DRX configuration parameters that are required to configure the sidelink DRX. The values of the DRX configuration parameters in the first DRX configuration information may be taken as be default values of DRX configuration parameters in configuring the sidelink DRX.

### Embodiment 3a

In an embodiment, if a UE (e.g., TX UE or RX UE) is in an RRC IDLE/INACTIVE mode, and cannot receive any SL DRX configuration information or SL DRX support indication information from the serving cell, it may perform sidelink groupcast or broadcast communication according to the SL DRX configuration in SL-V2X-PreconfigurationNR (e.g., a preconfigured message) or SystemInformation of the cell on the frequency which provides the inter-carrier NR sidelink DRX configuration.

### Embodiment 3b

In an embodiment, if a UE (TX UE or RX UE) is in an RRC IDLE/INACTIVE mode, and cannot receive any SL DRX configuration information or SL DRX support indication information from the serving cell, but if the UE can receive the SystemInformation of the cell on the frequency which provides the inter-carrier NR sidelink DRX configuration, it may perform the sidelink groupcast or broadcast communication according to the SL DRX configuration in the SystemInformation of the cell on the frequency which provides the inter-carrier NR sidelink DRX configuration. Otherwise, it may perform the sidelink groupcast or broadcast communication according to the SL DRX configuration in the SL-V2X-PreconfigurationNR message (e.g., a preconfigured message).

### Embodiment 4

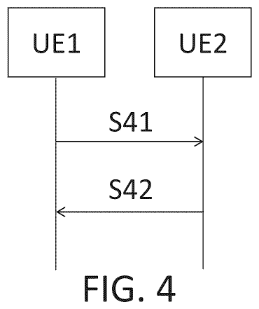

In an embodiment, the UE may initiate the sidelink UE capability transfer procedure upon indication from the upper layer when it needs UE radio access capability information. FIG. 4 shows the sidelink UE capability transfer procedure according to an embodiment of the present disclosure.

In this embodiment, in step S41, the UE1 sends a UECapabilityEnquirySidelink message to the UE2.

If the UE2 is in the RRC Connected mode, and configured with model (i.e., Scheduled mode) for resource allocation, and cannot receive any SL DRX configuration information or SL DRX support indication information from the serving cell, the UE2 indicates, in step S42, that the SL DRX is not supported in the UECapabilityInformationSidelink message.

Then if the TX UE (e.g., UE2) handover to another gNB that supports SL DRX, it may have to change the capability information.

### Embodiment 5a

In an embodiment, if the TX UE is in the RRC Connected mode, and configured with mode 1 (Scheduled mode) for resource allocation, and the serving cell does not support SL DRX (For example, the UE does not receive any SL DRX configuration information or SL DRX support indication information from the serving cell), even if the TX UE has the capability for SL DRX, after receiving sidelink assistance information from the RX UE, it will not configure the SL DRX for the RX UE. However, to avoid that the RX UE continues to send UE assistance information, the TX UE may send an indication for telling the RX UE that it should not send UE assistance information in the RRC reconfiguration message.

In particular, after the TX UE sends the UECapabilityInformationSidelink message carrying the indication of supporting SL DRX, it will send at least one of the following information in the RRCReconfigurationSidelink message:
1) an indication whether the sidelink assistance information can be sent from the peer UE (e.g., the RX UE).
2) an indication whether the sidelink DRX can be configured for the peer UE.

In this embodiment, for example, if the TX UE is in the RRC Connected mode, and configured with mode 1 (Scheduled mode) or for resource allocation, and the serving cell does not support SL DRX (for example, the UE does not receive any SL DRX configuration information or SL DRX support indication information from the serving cell), the TX UE sends the RRCReconfigurationSidelink message carrying the indication that the sidelink assistance information cannot be sent from the peer UE or sidelink DRX cannot be configured for the peer UE, then the RX UE will not send sidelink assistance information.

Then, if the TX UE moves to a serving cell that supports SL DRX, it may update the RRCReconfigurationSidelink. That is, the TX UE sends the RRCReconfigurationSidelink message carrying the indication that the sidelink assistance information can be sent from the peer UE or that the sidelink DRX can be configured for the peer UE, then the RX UE may send the sidelink assistance information.

If the TX UE is configured with mode 2 (i.e., UE selected Scheme) for resource allocation, it may update the RRCReconfigurationSidelink. That is the TX UE sends the RRCReconfigurationSidelink message carrying the indication that the sidelink assistance information can be sent from the peer UE or the sidelink DRX can be configured for the peer UE, then the RX UE may send the sidelink assistance information.

If the TX UE switches to an RRC IDLE/INACTIVE mode, it may update the RRCReconfigurationSidelink. That is TX UE send the RRCReconfigurationSidelink message carrying the indication that the sidelink assistance information can be sent from the peer UE or the sidelink DRX can be configured for the peer UE, then the RX UE may send the sidelink assistance information.

If the TX UE detects RLF (radio link failure) or timer T310 or T311 or T304 is running, it may update the RRCReconfigurationSidelink. That is, the TX UE sends the RRCReconfigurationSidelink message carrying the indication that the sidelink assistance information can be sent from the peer UE or the sidelink DRX can be configured for the peer UE, then the RX UE may send the sidelink assistance information.

### Embodiment 5b

In an embodiment, if the TX UE is in the RRC Connected mode, and the serving cell does not support SL DRX (for example, the UE does not receive any SL DRX configuration information or SL DRX support indication information from the serving cell), even if the TX UE has the capability of SL DRX, after receiving sidelink assistance information from the RX UE, the TX UE will not configure the SL DRX for the RX UE. However, to prevent the RX UE from continuously sending the UE assistance information, the TX UE may send an indication to tell the RX UE that it should not send UE assistance information in the RRC reconfiguration message.

In particular, after the TX UE sends the UECapabilityInformationSidelink message carrying the indication of supporting SL DRX, the TX UE will send at least one of the following information in the RRCReconfigurationSidelink message:
1) an indication whether the sidelink assistance information can be sent from the peer UE; and/or
2) an indication whether the sidelink DRX can be configured for the peer UE.

In this embodiment, for example, if the TX UE is in the RRC Connected mode, and the serving cell does not support the SL DRX (for example, the UE does not receive any SL DRX configuration information or SL DRX support indication information from the serving cell), the TX UE sends the RRCReconfigurationSidelink message carrying the indication that the sidelink assistance information cannot be sent from the peer UE or the sidelink DRX cannot be configured for the peer UE, then the RX UE may not send the sidelink assistance information.

Then, if the TX UE moves a serving cell that supports the SL DRX, it may update the RRCReconfigurationSidelink. That is, the TX UE sends the RRCReconfigurationSidelink message carrying the indication that the sidelink assistance information can be sent from the peer UE or the sidelink DRX can be configured for the peer UE, then the RX UE may send the sidelink assistance information.

If the TX UE switches to an RRC IDLE/INACTIVE mode, it may update the RRCReconfigurationSidelink. That is, the TX UE send the RRCReconfigurationSidelink message carrying the indication that the sidelink assistance information can be sent from the peer UE or the sidelink DRX can be configured for the peer UE, then the RX UE may send the sidelink assistance information.

### Embodiment 6

In an embodiment, the RX UE may send the assistance information to the TX UE, which includes: its desired on duration timer, DRX start offset, and DRX cycle. If the TX UE is in the RRC Connected mode, and configured with mode2, the TX UE may use the assistance information to determine the SL DRX configuration for the RX UE.

Thereafter, if the serving cell of the TX UE does not support SL DRX (for example, the UE does not receive any SL DRX configuration information or SL DRX support indication information from the serving cell), it will not report the SL DRX for the RX UE to the serving cell. If the serving cell of the TX UE supports the SL DRX, it will report the SL DRX for the RX UE to the serving cell.

In an embodiment, after receiving the message indicating that the SL DRX configuration is accepted from the RX UE and the serving cell indicates that it supports the SL DRX via the system information, the TX UE reports the SL DRX for the RX UE to the gNB. In an embodiment, after receiving the message indicating that the SL DRX configuration is accepted from RX UE and the gNB indicates that the SL DRX is allowed in the RRC reconfiguration message, the TX UE reports the SL DRX for the RX UE to the gNB.

### Embodiment 7

In an embodiment, if the serving cell supports SL DRX, the RX UE may report the QoS profile(s) of the sidelink QoS flow(s) of the associated destination configured by the upper layer for the NR sidelink groupcast or broadcast communication reception.

Considering that the RX UE may also report the QoS profile(s) of the sidelink QoS flow(s) of the associated destination configured by the upper layer for the NR sidelink unicast, groupcast or broadcast communication transmission, in order to reduce the overhead of signaling, an indication for transmission or reception, or both, is added in the IE (information element) of the QoS profile(s) of the sidelink QoS flow(s) of the associated destination.

In this embodiment, if a RX UE initiate the transmission of the SidelinkUEInformationNR message, the UE may set the contents of the SidelinkUEInformationNR message as follows: set a list sl-QoS-InfoList to include the QoS profile(s) of the sidelink QoS flow(s) of the associated destination configured by the upper layer for the NR sidelink communication transmission.

In an embodiment, the indication described above indicating whether UE is interested to receive NR sidelink communications for the Destination Identity. The IE includes the same number of entries, and listed in the same order, as in the IE SL-TxResourceReqList-r16. The entries with value 0 indicate the UE is not interested to receive the NR sidelink communication for the corresponding Destination Identity. The entries with value 1 indicate the UE is interested to receive the NR sidelink communication for the corresponding Destination Identity.

### Embodiment 8

In an embodiment, if the RX UE is in the RRC Connected mode, and the serving cell does not support SL DRX (for example, the UE does not receive any SL DRX configuration information or SL DRX support indication information from the serving cell), the RX UE will not send the configured SL DRX for sidelink unicast, or QoS of interested receiving service for sidelink Groupcast/Broadcast.

In this case, the gNB cannot consider aligning SL DRX and Uu DRX. Hence, it is better to allow the TX UE side to consider the Uu DRX configuration when configuring SL DRX for RX UE. Thus, the Uu DRX configuration may be included in the assistance information by the RX UE. Then, the TX UE side is in charge of making alignment between Uu DRX and SL DRX for the RX UE.

Thus, if the RX UE is configured with Uu DRX and the serving cell does not support SL DRX, it may include the Uu DRX configuration in the assistance information. Then, if the TX UE receives the assistance information including the Uu DRX configuration, it may take the Uu DRX configuration into account when determining the SL DRX for the RX UE.

### Embodiment 9

In an embodiment, in RRC_CONNECTED, the UE applies the NR sidelink communications parameters provided in RRCReconfiguration (if any). In RRC_IDLE or RRC_INACTIVE, the UE applies the NR sidelink communications parameters provided in system information (if any).

For other cases, the UEs apply the NR sidelink communications parameters provided in SidelinkPreconfigNR (if any). When the UE performs state transitions between the above three cases, the UE applies the NR sidelink communications parameters provided in the new state, after acquisition of the new configurations. Before acquisition of the new configurations, the UE continues applying the NR sidelink communications parameters provided in the old state.

In this embodiment, the following examples may be considered:
A) The TX UE changes resource allocation mode from mode 1 to mode 2 in at least one of the following cases:
Case 1A) the TX UE is in the RRC Connected mode and the gNB is configured to change mode. After receiving the mode change configuration, the TX UE can decide whether to update the SL DRX configuration for the RX UE. After the SL DRX configuration of the RX UE is updated, the TX UE may report or not report the updated SL DRX configuration to the gNB.
Case 2A) the timer T310 and/or T311 is running.
Case 3A) the timer T304 is running.
Case 4A) TX UE switches from an RRC Connected mode to an RRC IDLE/INACTIVE mode.

In the cases above, since the UE lose the connection with the gNB, it cannot report the updated SL DRX configuration.
B) TX UE changes mode from mode 2 to mode 1 in at least one of the following cases:
Case 1B) the TX UE is in the RRC Connected mode and the gNB changes mode.
Case 2B) the TX UE switches from an RRC IDLE/INACTIVE mode to an RRC Connected mode.
Case 3B) the handover of the TX UE successes.
Case 4B) the connection reestablishment of the TX UE successes.

In order to let the gNB configures the SL DRX configuration properly, the TX UE may forward the assistance information from the RX UE to the gNB when TX UE changes the mode from mode 2 to mode 1.

In order to not change the SL DRX configuration if not very necessary, the TX UE can report the current SL DRX configuration of the RX UE to the gNB when above cases happen.

### Embodiments 10 and 11

In some embodiments, since both TX UE and the serving cell of the TX UE can configure SL DRX for the RX UE, if the serving cell of the TX UE configure SL DRX for the RX UE, even if no SL DRX or no acceptable SL DRX is received, the RX UE may not do anything for it. But if the TX UE configures SL DRX for the RX UE, if no SL DRX or no acceptable SL DRX is received for a long time, the RX UE can consider releasing the link or using default SL DRX. In this way, the TX UE may try its best to take the requirement of the RX UE into account when configuring SL DRX. Therefore, there is a need to let the RX UE know it is the TX UE or the serving cell of the TX UE configures SL DRX for the RX UE.

Embodiment 10 discusses the case of no SL DRX is received for a long time.

Embodiment 11 discusses the case of no acceptable SL DRX is received for multiple times.

### Embodiment 10

### Step1:

The TX UE send an indication to the RX UE, and the indication indicating at least one of:

the TX UE or the serving cell of the TX UE configures SL DRX for the RX UE; and/or the TX UE is configured with the sidelink resource allocation mode 1 or the sidelink resource allocation mode 2;

### Step2:

If the TX UE configures SL DRX for the RX UE or the TX UE is configured with a sidelink resource allocation mode 2, the RX UE may start/restart a first timer upon sending the assistance information to the TX UE.

When the RX UE receives a SL DRX configuration from the TX UE, it stops the first timer.

If the first timer is expired, the RX UE can perform one of:
release the PC5 link with the TX UE; or
using the default SL DRX configuration which is preconfigured or is received from the serving cell of the RX UE;
In addition, the value of the first timer is preconfigured or is received from the serving cell of the RX UE.

### Embodiment 11

If the RX UE sends a SL DRX rejection indication to the TX UE, it increments the value of a counter COUNTER-x by 1.

If COUNTER-x reach the maximum value (M), the RX UE can perform one of:
release the PC5 link with the TX UE; or
using the default SL DRX configuration which is preconfigured or is received from the serving cell of the RX UE;

The RX UE is configured with the counter CONTER-X and initialize the value of CONTER-X to zero.

If the RX UE send a SL DRX accept indication to the TX UE, the RX UE sets the value of CONTER-X to zero.

In addition, the maximum value (M) is preconfigured or is received from the serving cell of the RX UE.

Furthermore, the RX UE increments the value of COUNTER-x by 1 only when following conditions are met:
the RX UE send an SL DRX rejection indication to the TX UE; and
the TX UE configures SL DRX for the RX UE or the TX UE is configured with the sidelink resource allocation mode 2.

Furthermore, the RX UE receives an indication from the TX UE, and the indication indicating at least one of:
the TX UE or the serving cell of the TX UE configures SL DRX for the RX UE; and/or
the TX UE is configured with the sidelink resource allocation mode 1 or the sidelink resource allocation mode 2.

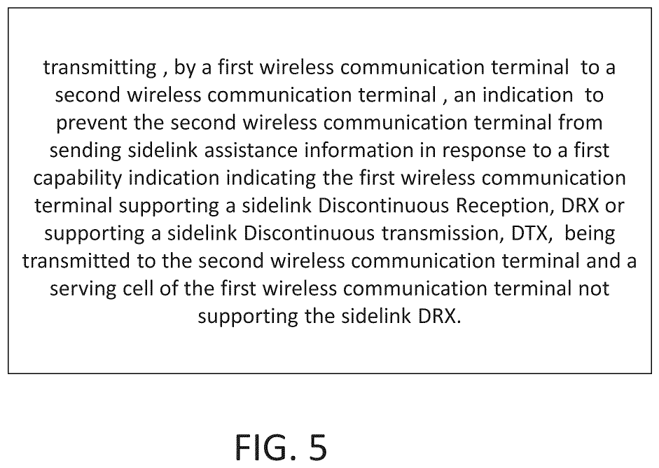

FIGS. 5 to 11 show flowcharts of a wireless communication method according to an embodiment of the present disclosure.

As shown in FIG. 5, in an embodiment, the wireless communication method includes: transmitting, by a first wireless communication terminal to a second wireless communication terminal, an indication to prevent the second wireless communication terminal from sending sidelink assistance information in response to a first capability indication indicating the first wireless communication terminal supporting a sidelink Discontinuous Reception, DRX or supporting a sidelink Discontinuous transmission, DTX, being transmitted to the second wireless communication terminal and a serving cell of the first wireless communication terminal not supporting the sidelink DRX.

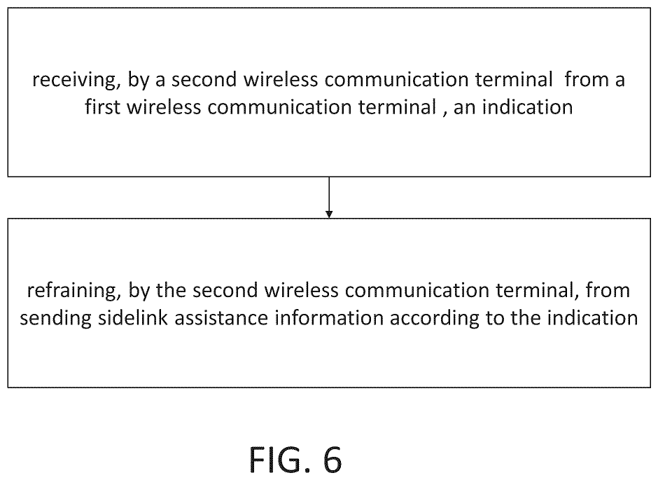

As shown in FIG. 6, in an embodiment, the wireless communication method includes: receiving, by a second wireless communication terminal from a first wireless communication terminal, an indication; and refraining, by the second wireless communication terminal, from sending sidelink assistance information according to the indication; wherein the indication is received after a first capability indication indicating the first wireless communication terminal supporting a sidelink Discontinuous Reception, DRX, or supporting a sidelink Discontinuous Transmission, DTX, being received by the second wireless communication terminal and in response to a serving cell of the first wireless communication terminal not supporting the sidelink DRX.

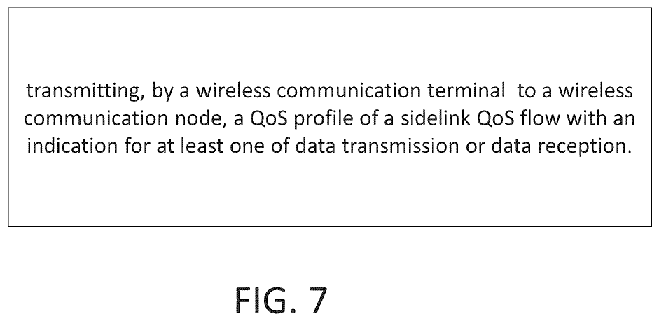

As shown in FIG. 7, in an embodiment, the wireless communication method includes: transmitting, by a wireless communication terminal to a wireless communication node, a QoS profile of a sidelink QoS flow with an indication for at least one of data transmission or data reception.

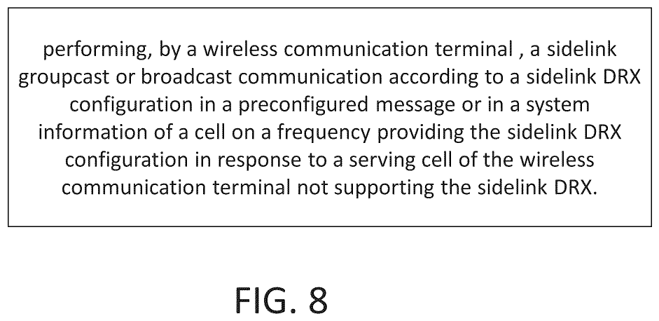

As shown in FIG. 8, in an embodiment, the wireless communication method includes: performing, by a wireless communication terminal, a sidelink groupcast or broadcast communication according to a sidelink DRX configuration in a preconfigured message or in a system information of a cell on a frequency providing the sidelink DRX configuration in response to a serving cell of the wireless communication terminal not supporting the sidelink DRX.

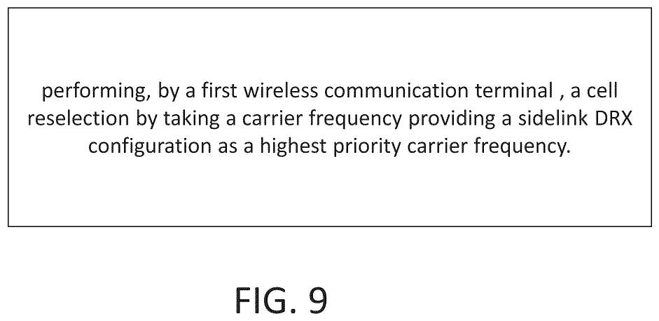

As shown in FIG. 9, in an embodiment, the wireless communication method includes: performing, by a first wireless communication terminal, a cell reselection by taking a carrier frequency providing a sidelink DRX configuration as a highest priority carrier frequency.

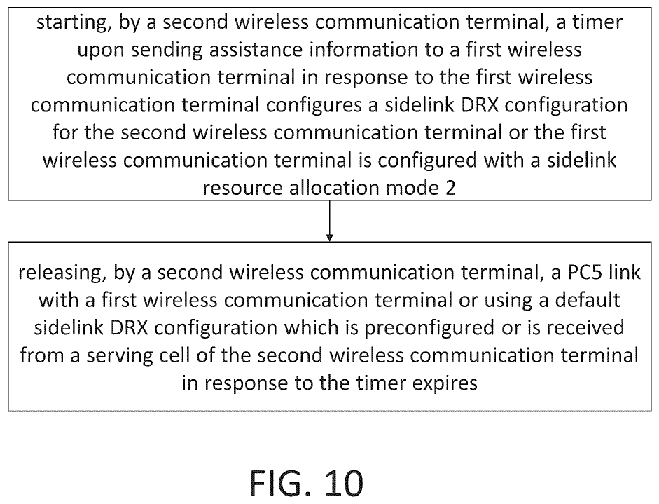

As shown in FIG. 10, in an embodiment, the wireless communication method includes: starting, by a second wireless communication terminal, a timer upon sending assistance information to a first wireless communication terminal in response to the first wireless communication terminal configures a sidelink DRX configuration for the second wireless communication terminal or the first wireless communication terminal is configured with a sidelink resource allocation mode 2; and releasing, by a second wireless communication terminal, a PC5 link with a first wireless communication terminal or using a default sidelink DRX configuration which is preconfigured or is received from a serving cell of the second wireless communication terminal in response to the timer expires.

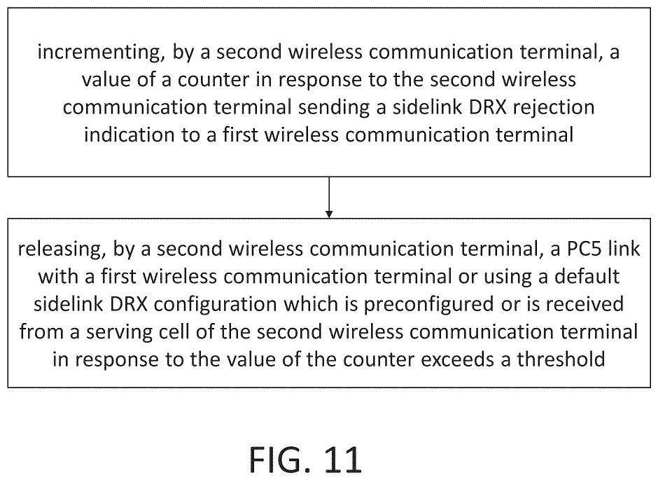

As shown in FIG. 11, in an embodiment, the wireless communication method includes: incrementing, by a second wireless communication terminal, a value of a counter in response to the second wireless communication terminal sending a sidelink DRX rejection indication to a first wireless communication terminal; and releasing, by a second wireless communication terminal, a PC5 link with a first wireless communication terminal or using a default sidelink DRX configuration which is preconfigured or is received from a serving cell of the second wireless communication terminal in response to the value of the counter exceeds a threshold.

While various embodiments of the present disclosure have been described above, it should be understood that they have been presented by way of example only, and not by way of limitation. Likewise, the various diagrams may depict an example architectural or configuration, which are provided to enable persons of ordinary skill in the art to understand example features and functions of the present disclosure. Such persons would understand, however, that the present disclosure is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any one of the above-described example embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any one of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A skilled person would further appreciate that any one of the various illustrative logical blocks, units, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software unit”), or any combination of these techniques.

To clearly illustrate this interchangeability of hardware, firmware and software, various illustrative components, blocks, units, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure. In accordance with various embodiments, a processor, device, component, circuit, structure, machine, unit, etc. can be configured to perform one or more of the functions described herein. The term “configured to” or “configured for” as used herein with respect to a specified operation or function refers to a processor, device, component, circuit, structure, machine, unit, etc. that is physically constructed, programmed and/or arranged to perform the specified operation or function.

Furthermore, a skilled person would understand that various illustrative logical blocks, units, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, units, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein. If implemented in software, the functions can be stored as one or more instructions or code on a computer-readable medium. Thus, the steps of a method or algorithm disclosed herein can be implemented as software stored on a computer-readable medium.

Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “unit” as used herein, refers to software, firmware, hardware, and any combination of these elements for performing the associated functions described herein. Additionally, for purpose of discussion, the various units are described as discrete units; however, as would be apparent to one of ordinary skill in the art, two or more units may be combined to form a single unit that performs the associated functions according embodiments of the present disclosure.

Additionally, memory or other storage, as well as communication components, may be employed in embodiments of the present disclosure. It will be appreciated that, for clarity purposes, the above description has described embodiments of the present disclosure with reference to different functional units and processors. However, it will be apparent that any suitable distribution of functionality between different functional units, processing logic elements or domains may be used without detracting from the present disclosure. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the implementations described in this disclosure will be readily apparent to those skilled in the art, and the general principles defined herein can be applied to other implementations without departing from the scope of the claims. Thus, the disclosure is not intended to be limited to the implementations shown herein, but is to be accorded the widest scope consistent with the novel features and principles disclosed herein, as recited in the claims below.

What is claimed is:

1. A wireless communication method comprising:
transmitting, by a first wireless communication terminal to a second wireless communication terminal, an indication to prevent the second wireless communication terminal from sending sidelink assistance information in response to a first capability indication indicating the first wireless communication terminal supporting a sidelink Discontinuous Reception (DRX) or supporting a sidelink Discontinuous transmission (DTX) being transmitted to the second wireless communication terminal and a serving cell of the first wireless communication terminal not supporting the sidelink DRX,
wherein the indication comprises at least one of: an indication indicating that the sidelink assistance information is not allowed to be transmitted, or an indication indicating that a sidelink DRX configuration of the second wireless communication terminal is unable to be configured by the first wireless communication terminal or a serving cell of the first wireless communication terminal.

2. The wireless communication method of claim 1, wherein the first wireless communication terminal transmits a second capability indication indicating that the first wireless communication terminal does not support the sidelink DRX in response to the first wireless communication terminal being in a Radio Resource Control (RRC) connected mode and the serving cell of the first wireless communication terminal not supporting the sidelink DRX.

3. The wireless communication method of claim 1, wherein the first wireless communication terminal reports a sidelink DRX configuration for the second wireless communication terminal to a wireless communication node in response to a message indicating the sidelink DRX configuration being accepted by the second wireless communication terminal and the serving cell of the first wireless communication terminal supporting the sidelink DRX.

4. The wireless communication method of claim 1, wherein the first wireless communication terminal determines the serving cell of the first wireless communication terminal not supporting the sidelink DRX in response to not receiving information of sidelink DRX configuration or sidelink DRX support indication from the serving cell.

5. The wireless communication method of claim 1, wherein the first wireless communication terminal reports a sidelink DRX configuration for the second wireless communication terminal to a wireless communication node in response to a message indicating the sidelink DRX configuration being accepted by the second wireless communication terminal and the wireless communication node supporting the sidelink DRX.

6. The wireless communication method of claim 1, wherein the first wireless communication terminal determines a sidelink DRX configuration for the second wireless communication terminal taking into account a Uu DRX configuration of the second wireless communication terminal in the sidelink assistance information from the second wireless communication terminal.

7. The wireless communication method of claim 1, wherein the first wireless communication terminal transmits the sidelink assistance information received from the second wireless communication terminal to a wireless communication node in response to at least one of:
the first wireless communication terminal being in an RRC connected mode and the wireless communication node configuring to change a sidelink resource allocation mode from mode 2 to mode 1;
the first wireless communication terminal switching from an RRC idle or inactive mode to an RRC connected mode;
a handover of the first wireless communication terminal succeeding; or
a connection reestablishment of the first wireless communication terminal succeeding.

8. The wireless communication method of claim 1, wherein the first wireless communication terminal transmits the sidelink DRX configuration of the second wireless communication terminal to a wireless communication node in response to at least one of:
the first wireless communication terminal being in an RRC connected mode and the wireless communication node configuring to change a sidelink resource allocation mode from mode 2 to mode 1;
the first wireless communication terminal switching from an RRC idle or inactive mode to an RRC connected mode;
a handover of the first wireless communication terminal succeeding; or
a connection reestablishment of the first wireless communication terminal succeeding.

9. A wireless communication method comprising:
receiving, by a second wireless communication terminal from a first wireless communication terminal, an indication; and
refraining, by the second wireless communication terminal, from sending sidelink assistance information according to the indication;
wherein the indication is received after a first capability indication indicating the first wireless communication terminal supporting a sidelink Discontinuous Reception (DRX), or supporting a sidelink Discontinuous Transmission (DTX) being received by the second wireless communication terminal and in response to a serving cell of the first wireless communication terminal not supporting the sidelink DRX,
wherein the indication comprises at least one of: an indication indicating that the sidelink assistance information is not allowed to be transmitted, or an indication indicating that a sidelink DRX configuration of the second wireless communication terminal is unable to be configured by the first wireless communication terminal or a serving cell of the first wireless communication terminal.

10. The wireless communication method of claim 9, wherein the second wireless communication terminal receives a second capability indication indicating the first wireless communication terminal does not support the sidelink DRX in response to the first wireless communication terminal being in a Radio Resource Control (RRC) connected mode and the serving cell of the first wireless communication terminal not supporting the sidelink DRX.

11. The wireless communication method of claim 9, wherein the second wireless communication terminal transmits a Uu DRX configuration of the second wireless communication terminal to the first wireless communication terminal in the sidelink assistance information in response to a serving cell of the second wireless communication terminal not supporting the sidelink DRX.

12. The wireless communication method of claim 11, wherein the second wireless communication terminal refrains from transmitting at least one of a sidelink DRX configuration or a quality of service (QOS) profile of interested receiving service for a sidelink QoS flow to a wireless communication node.

13. A first wireless communication terminal, comprising:
a communication unit; and
a processor configured to: transmit via the communication unit, to a second wireless communication terminal, an indication to prevent the second wireless communication terminal from sending sidelink assistance information in response to a first capability indication indicating the first wireless communication terminal supporting a sidelink Discontinuous Reception (DRX) or supporting a sidelink Discontinuous transmission (DTX) being transmitted to the second wireless communication terminal and a serving cell of the first wireless communication terminal not supporting the sidelink DRX,
wherein the indication comprises at least one of: an indication indicating that the sidelink assistance information is not allowed to be transmitted, or an indication indicating that a sidelink DRX configuration of the second wireless communication terminal is unable to be configured by the first wireless communication terminal or a serving cell of the first wireless communication terminal.

14. The first wireless communication terminal of claim 13, wherein the first wireless communication terminal transmits, via the communication unit, a second capability indication indicating that the first wireless communication terminal does not support the sidelink DRX in response to the first wireless communication terminal being in a Radio Resource Control (RRC) connected mode and the serving cell of the first wireless communication terminal not supporting the sidelink DRX.

15. The first wireless communication terminal of claim 13, wherein the first wireless communication terminal reports, via the communication unit, a sidelink DRX configuration for the second wireless communication terminal to a wireless communication node in response to a message indicating the sidelink DRX configuration being accepted by the second wireless communication terminal and the serving cell of the first wireless communication terminal supporting the sidelink DRX.

16. The first wireless communication terminal of claim 13, wherein the first wireless communication terminal determines the serving cell of the first wireless communication terminal not supporting the sidelink DRX in response to not receiving information of sidelink DRX configuration or sidelink DRX support indication from the serving cell.

17. The first wireless communication terminal of claim 13, wherein the first wireless communication terminal reports, via the communication unit, a sidelink DRX configuration for the second wireless communication terminal to a wireless communication node in response to a message indicating the sidelink DRX configuration being accepted by the second wireless communication terminal and the wireless communication node supporting the sidelink DRX.

18. The first wireless communication terminal of claim 13, wherein the first wireless communication terminal determines a sidelink DRX configuration for the second wireless communication terminal taking into account a Uu DRX configuration of the second wireless communication terminal in the sidelink assistance information from the second wireless communication terminal.

19. The first wireless communication terminal of claim 13, wherein the first wireless communication terminal transmits, via the communication unit, the sidelink assistance information received from the second wireless communication terminal to a wireless communication node in response to at least one of:
the first wireless communication terminal being in an RRC connected mode and the wireless communication node configuring to change a sidelink resource allocation mode from mode 2 to mode 1;
the first wireless communication terminal switching from an RRC idle or inactive mode to an RRC connected mode;
a handover of the first wireless communication terminal succeeding; or
a connection reestablishment of the first wireless communication terminal succeeding.

20. The first wireless communication terminal of claim 13, wherein the first wireless communication terminal transmits, via the communication unit, the sidelink DRX configuration of the second wireless communication terminal to a wireless communication node in response to at least one of:
the first wireless communication terminal being in an RRC connected mode and the wireless communication node configuring to change a sidelink resource allocation mode from mode 2 to mode 1;
the first wireless communication terminal switching from an RRC idle or inactive mode to an RRC connected mode;
a handover of the first wireless communication terminal succeeding; or
a connection reestablishment of the first wireless communication terminal succeeding.
